(19) United States
(12) Patent Application Publication
(10) Pub. No.: US 2005/0202364 A1
(43) Pub. Date: Sep. 15, 2005

(54) Abrasive tool for dental use

(76) Inventors: Paolo Fornasari, Cordenons (IT); Cristiano Vettori, Pordenone (IT)

Correspondence Address: BUCKNAM AND ARCHER, 1077 NORTHERN BOULEVARD, ROSLYN, NY, 11576, US

(21) Appl. No.: 10/503,965

(22) PCT Filed: Dec. 12, 2003
(86) PCT No.: PCT/EP03/14118

§ 371 Date: Aug. 9, 2004

(30) Foreign Application Priority Data
Dec. 18, 2002 (IT) PN2002 A 000098
Mar. 31, 2003 (IT) PN2003 A 000023

(51) Int. Cl. A61C 3/02

(52) U.S. Cl. 433/88; 433/32

(57) ABSTRACT

Abrasive tool for dental uses, adapted to act on the teeth of persons for performing abrasive operations on the same teeth, so as to remove decayed parts etc. . . . therefrom. Tool comprising first fluid/liquid container means (7) provided with heating means (23) to keep fluid/liquid at a pre-established temperature; second fluid/liquid container means (13) communicating with said first container means (7) through a pump (9); third container means (12, 55) of an abrasive solution; and handle means (16) connected with at least a rod (17) and shaped for being handled and oriented toward the teeth parts to be treated and communicating with the pump (9) through a flexible and reinforced pipe (18). The pump (9) is operated in such a way to draw fluid/liquid from said first container means (7) and to convey it into said second container means (13) with such a high pressure that to convey the relative abrasive solution contained into said third container means (12, 55) through said handle means (16) and said rod (17), by directing it at a very high speed in the form of a jet of fluid/liquid and abrasive solution against the teeth parts to be treated, with subsequent final suction of fluid/liquid and said abrasive solution from the patient's mouth.

The invention relates to an abrasive tool for dental uses, adapted to act on the teeth of persons for performing abrasive operations on the same teeth so as to remove decayed parts etc. . . . therefrom with an effective, quick and painless operation.

Abrasive tools of various kind for dental uses are known, and above all for abrading the teeth of persons requiring some decayed parts etc. . . . thereof to be removed and repaired. Generally, these abrasive tools are constituted by removable milling cutters, mounted onto rods joined through flexible conduits with appliances called dental engines, said milling cutters being driven with high rpm by means of driving members (turbines) included in the same appliances, and being associated with suitable fluid distributing systems, preferably fluid/water distributing systems, to provide for the cooling of the teeth parts under treatment. These abrasive tools are able to ensure effective abrasions of the teeth with limited inconvenients for the patients under treatment, however they produce some unavoidable vibrations and noises at high frequencies, anyway of reduced intensities, which may be troublesome for the patients from both the psychological and physical point of view, in that they may cause pain sensations, even if limited, which may create apprehensions and fears on the same patients. Further abrasive tools used at the present time are constituted by the so-called “laser dental engines”, which are made for generating laser light beams which are directed against the teeth parts to be drilled. These tools require a high accuracy and maneuverability to provide for the localized drill of teeth, and moreover they develop a high temperature when are coming into contact with the teeth tissues, in that the teeth parts to be removed are vaporized by the laser light beam, which circumstances make very difficult the use of these abrasive tools, and also involve considerable investments of capital for buying the laser appliances and training high skilled labour personnel. Still further abrasive tools which are employed are constituted by compressed air abrasive systems, set for transporting adequately sized abrasive powders and for directing them under high pressure against the teeth parts to be treated. Also these systems have not revealed themselves enough reliable, above all for the difficulty to effectively cool down the teeth under treatment, by means of water circulation systems, in that often there are produced excessive coolings of the teeth which involve painful sensations to the patients and produce considerable and annoying powder dispersions. Finally, other teeth abrasive technics are constituted by chemical systems, which however involve a disagreeable taste and often do not permit to prove the effectiveness of the caries removal action performed by the same systems, and require as well the unavoidable use of mechanical instruments (excavators) for removing caries, which are considered always trying by the patients. The object of the present invention is to provide for an abrasive tool shaped and operating in a new fashion, which permits to eliminate the drawbacks and applicative limits of the above mentioned currently employed abrasive systems, and is able to perform an adjustable abrasion of the teeth with an effective, quick and painless operation thereof This abrasive tool is made with the constructive characteristics substantially described, with particular reference to the attached patent claims.

The invention will be better understood from the following description, given solely by way of not limiting example thereof and with reference to the accompanying drawings wherein:

FIG. 1 shows a schematic front view of an abrasive tool according to the invention, in a first embodiment thereof;

FIG. 2 shows a schematic front view of an enlarged constructive item of the abrasive tool of FIG. 1, displaced on a first operative position thereof;

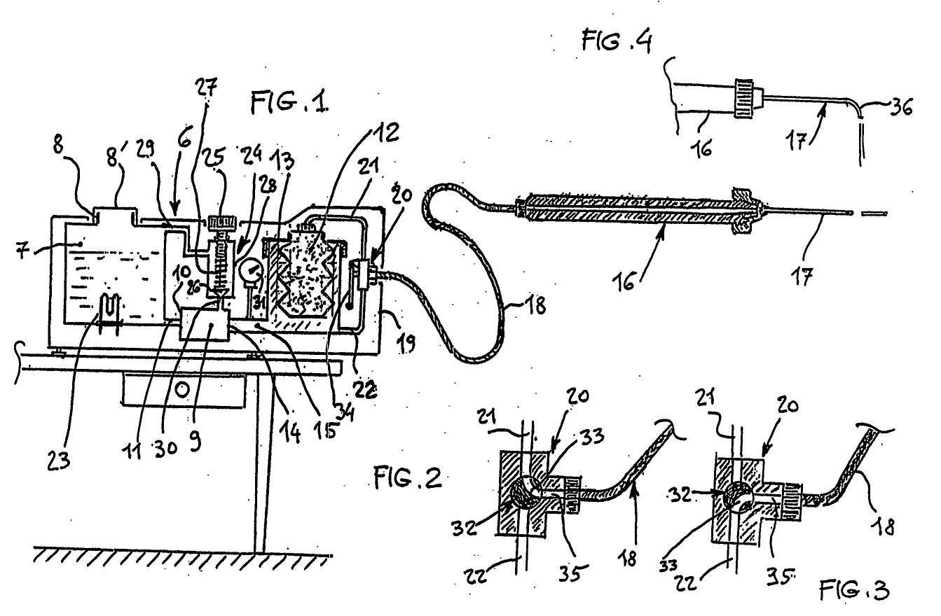

FIG. 3 shows with the same view the constructive item of FIG. 2, displaced on a second operative position thereof;

FIG. 4 shows a schematic front view of another constructive item of the abrasive tool of FIG. 1;

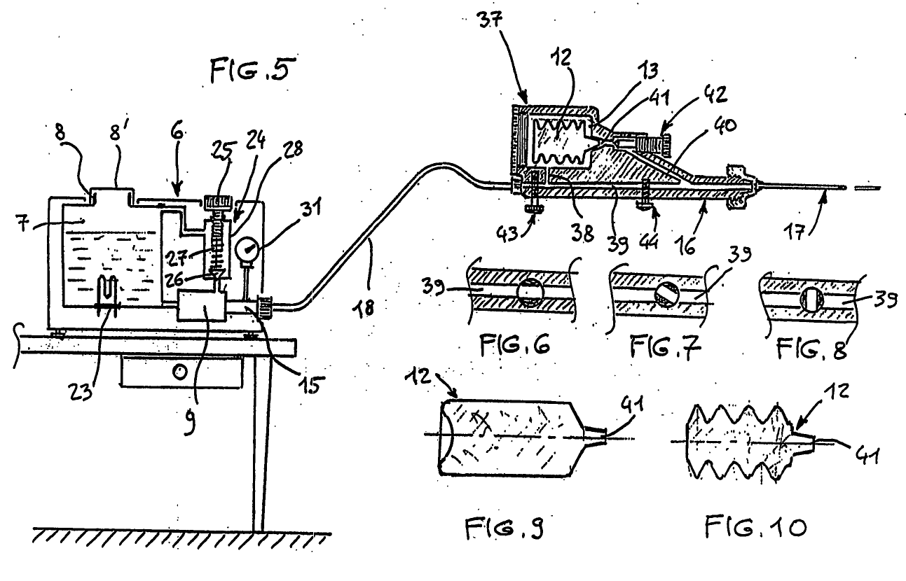

FIG. 5 shows a schematic front view of an abrasive tool according to the invention, in a second embodiment thereof;

FIGS. 6, 7 and 8 show a schematic front view of an enlarged constructive item of the abrasive tool of FIG. 5, on three different operative positions thereof;

FIGS. 9 and 10 show a schematic front view of a further enlarged constructive item of the abrasive tool of FIG. 5, on two different versions thereof;

FIG. 11 shows a perspective front view of an abrasive tool according to the invention, in a third embodiment thereof;

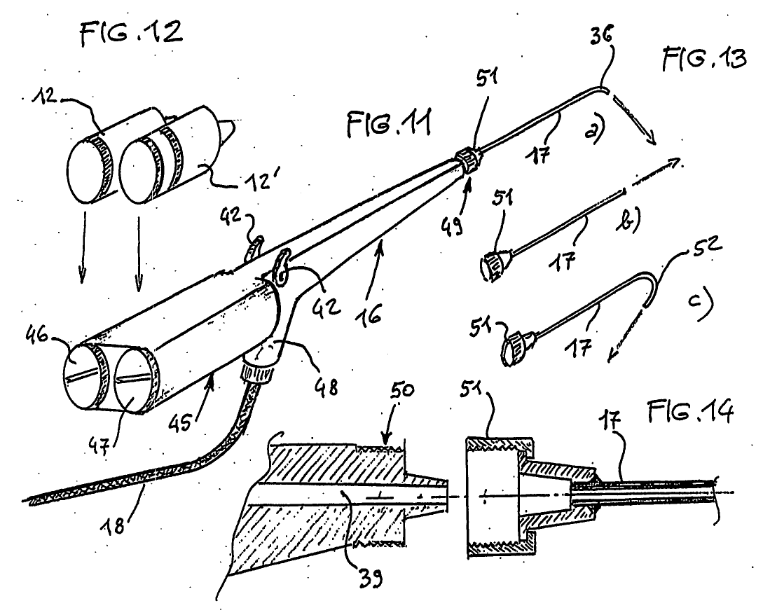

FIG. 12 shows a perspective front view of a first constructive item of the abrasive tool of FIG. 11;

FIG. 13 shows a perspective front view of a second constructive item of the abrasive tool of FIG. 11, on three different versions thereof;

FIG. 14 shows a cross sectioned front view of the first constructive item of FIG. 12, in a disassembled condition thereof;

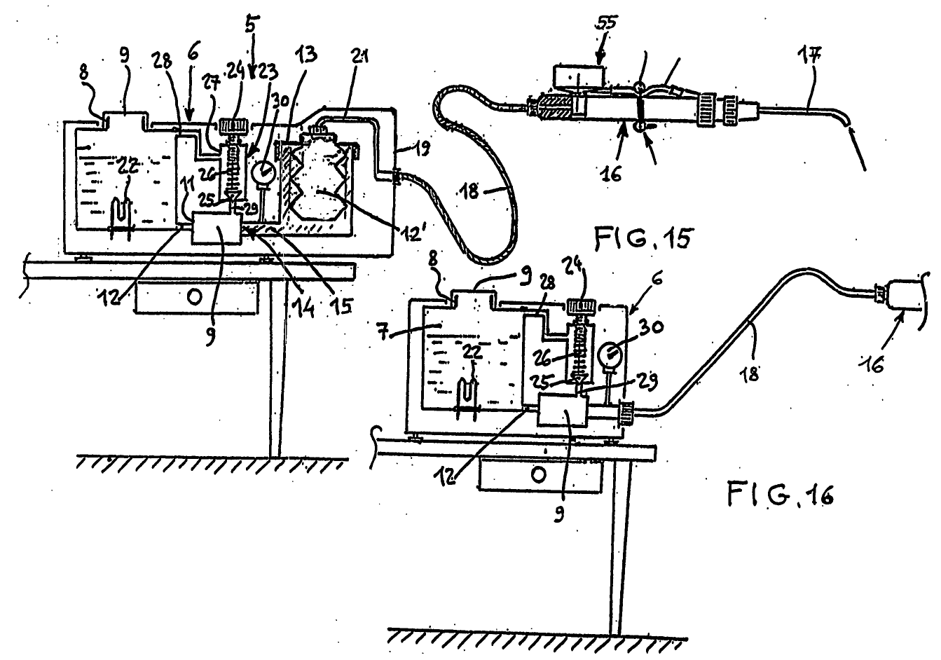

FIG. 15 shows a schematic front view of an abrasive tool according to the invention, in a fourth embodiment thereof;

FIG. 16 shows a schematic front view of the abrasive tool according to the invention, in a fifth embodiment thereof;

FIG. 17 shows a schematic front view, partially cutaway in a longitudinal direction, of an enlarged constructive item of the abrasive tool represented on FIGS. 15 and 16;

FIG. 18 shows a schematic side view along the line A-A of the constructive item of FIG. 17;

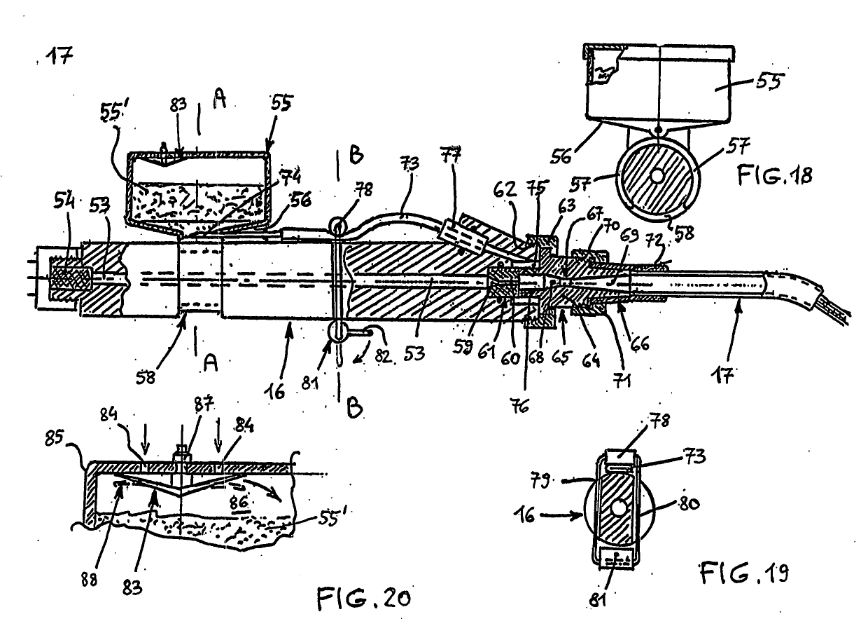

FIG. 19 shows a schematic side view along the line B-B of the constructive item of FIG. 17;

FIG. 20 shows a schematic front and enlarged view of an item of the component of FIG. 17.

FIGS. 1-3 schematically represent an abrasive tool 5 for dental uses according to the invention, in a first embodiment thereof, adapted to act on the person's teeth in a manner to perform drilling operations on the same teeth, so as to remove decayed parts etc. . . . therefrom with an effective, quick and painless operation thereof. With particular reference to FIG. 1, it is noted that this abrasive tool is substantially constituted by a box-like envelope 6 enclosing at least a reservoir 7 of a fluid/liquid, preferably water, provided with a filling mouthpiece 8 closed by a plug 8′, a high pressure pump 9 the suction inlet 10 of which is communicating with the reservoir 7 through a conduit 11, a cartridge 12 having large capacity containing the abrasive material which will be described later and made of a deformable plastic material and a container 13 of high pressure resistant material in which the cartridge 12 is housed, which is communicating with the delivery side 14 of the pump 9 through a conduit 15, the abrasive tool being also constituted by a thin internally hollow rectilinear extended handle 16, an end portion of which is provided with a rod 17 provided for the function which will be described later, and the other end portion of which is joined with a corresponding end portion of a thin reinforced and extended flexible pipe 18 made of a material resistant to very high pressures, said flexible pipe being entering with its other end portion the wall 19 of the box-like envelope 6 and joined with a valve member 20 communicating with the interior of both the cartridge 12, through a first conduit 21, and the container 13 though a second conduit 22. In turn, the reservoir 7 is provided internally with heating means, constituted by at least an electric resistance 23 adapted to be turned on and off on intervals by means of a thermostatic control, a timer etc. . . . so as to keep steady at the ambient temperature the fluid/liquid introduced in the reservoir through the filling mouthpiece 8. Moreover, the pump 9 may be made of a different type and commonly available on the market, for example it may be a piston pump, a blade pump, a plunger pump etc. . . . and serves to suck the fluid/liquid introduced and heated into the reservoir 7 and to introduce it in the container 13 at a high pressure, such that to cause the compression of the flexible cartridge 12 and the consequent coming out from this latter, through the conduit 21, of the abrasive material contained therein The operative pressure of the fluid/liquid being introduced into the container 13 is adjusted through a pressure regulator 24 of conventional type, in the example referred to formed by a regulating ring nut 25 acting on a valve member 26, through a spring 27, both being contained in a receptacle 28 communicating with both the reservoir 7, through a conduit 29, and the pump 9 through a further conduit 30, in a way that the fluid/liquid pressure is adjusted by acting on both the ring nut 25 and the valve member 26, thereby varying the fluid/liquid flow section through the conduit 30 and the so adjusted operating pressure value is indicated by a conventional pressure gauge 31 connected to the conduit 15. In turn, the cartridge 12 is filled with abrasive material constituted by a solution of micronized aluminium hydroxide, fluid/liquid and at least a starch of conventional type, and these components are mixed together in advance at pre-established ratios thereof in a manner that when the teeth drilling operation is required the fluid/liquid high pressure produced by the pump 9 causes the cartridge 12 to be compressed, with consequent outflow of the solution contained in the same cartridge as an abrasive material liquid jet which, by passing through the handle 16 and the rod 17, which is applied on the tooth part to be treated, provides for removing such tooth part. The passage of the abrasive solution is adjusted through the valve member 20 which, as visible in the enlarged items represented on FIGS. 2 and 3, is shaped with an inner switching element 32 provided with an inner through conduit 33 and controlled by an outer handle 34, in a manner to be displaced by the same into two different operative positions, in order to put into communication selectively the inner conduit 35 of the flexible pipe 18 with either the conduit 21, and therefore the interior of the cartridge 12 (see FIG. 2) when the teeth drilling operation and therefore the passage of the abrasive solution is required, or the conduit 22 and therefore the interior of the container 13 (see FIG. 3) when the teeth drilling operation isn't required, and it is requested to clean the different conduits after a determined number of operations performed with the abrasive tool referred to. Such cleaning operation may be effected also at the end of each operative cycle. With the abrasive solution referred to, the aluminium hydroxide particles serve to provide for the abrasion of the decayed parts of teeth when they are directed against such decayed parts with a high speed spray jet through the rod 17, while the starch contained in the solution serves to keep such abrasive particles in suspension for a time enough in the solution, in a manner that when the abrasion is requested such abrasive particles can be conveyed by the fluid/liquid solution and cannot fall down again on the bottom of the cartridge 12. Moreover, each cartridge can be also filled with a paste added with a high concentrated abrasive powder. When each cartridge 12 has been emptied, it may be removed easy and quickly from its seat and replaced with another cartridge of the same kind. It is to point out also that the rod 17 of the present abrasive tool may be made with different shapes and sizes, so as to have access on different positions and with different energy to teeth, and to this aim this rod may be made either with rectilinear shape, as shown on FIG. 1, or with a curved shaped end portion 36 thereof, visible on FIG. 4, or with any other shape. FIG. 5 now shows the present abrasive tool in a second embodiment thereof, while FIGS. 6-10 show several component parts included into this abrasive tool. With particular reference to FIG. 5, it is noted that in this case the abrasive tool is always constituted like that previously described, so that its component parts are marked with the same reference numerals, and differs from the above mentioned tool in that in this case the box-like envelope 6 isn't provided with the cartridge 12, the container 13, the valve member 20 and the relative conduits 21 and 22, and the flexible pipe 18 is joined with its end portion directly with the conduit 15, downstream the pressure gauge 31. Besides, in this case these component parts are housed directly inside an enlarged portion 37 of the handle 16, which is tapered towards the free end portion of the same handle, and in particular in this case it is noted that the container 13 containing the flexible cartridge 12 is arranged preferably in a horizontal direction on the upper zone of the enlarged portion 37 and is communicating through a conduit 38 with the inner conduit 39 of the handle 16, which in turn is communicating with the rod 17 and is joined with the inner conduit 35 of the flexible pipe 18. Such cartridge 12 is a small-sized cartridge and contains aluminium hydroxide powder with a higher concentration than the preceding cartridge. It may also contain a paste with high concentrated abrasive powder. A further inclined conduit 40 is also provided in the enlarged portion 37, which is communicating at the one end portion thereof with the outflow mouthpiece 41 of the cartridge 12, with the interposition of a lock 42 regulating the section of the same outflow mouthpiece, and at the other end portion thereof with the inner conduit 39 of the handle 16. The purpose of such conduit 40 is to permit the abrasive solution contained in the cartridge to leave it, with a metering effected by acting on the lock-regulator 42, thanks to the compression exerted against the cartridge by fluid/liquid entering the container 13, through the conduits 39 and 38. The handle 16 is also provided with valve members 43 and 44 regulating the fluid/liquid flow through the conduit 39, which are arranged respectively upstream the offtake conduit 38 and between this latter and the joining point between such inner conduit 39 and the conduit 40. These valve members may be displaced in three different operative positions for regulating fluid/liquid flow, respectively a first position (see FIG. 6) in which the conduit 39 is open and therefore fluid/liquid may pass through it, a second position (see FIG. 7) in which the conduit 39 is partially closed, so that a smaller fluid/liquid quantity may flow through it, and a third position (see FIG. 8) in which the conduit 39 is fully closed so that any fluid/liquid passage through it is prevented. From FIGS. 9 and 10 there are noted by way of example two different kinds of flexible cartridges 12 which may be used, namely a cylindrical cartridge (FIG. 9) and a pleated cartridge (FIG. 10), but of course such cartridges may be made also with different shapes, thus without departing from the protection sphere of the present invention. Therefore, in this solution through the flexible pipe 18 the abrasive solution does' not more pass, rather it passes only the fluid/liquid conveying the abrasive solution contained in the cartridge housed into the handle 16, thereby excluding with safety that such flexible pipe be clogged by the abrasive solution. Moreover, instead of a single cartridge only, the handle may house also one or more additional cartridges, which may contain an abrasive solution with either the same grain size or also different grain size, in order to get different levels of abrasion. Furthermore, in this case by acting on the valve members 43 and 44 it is also possible to vary the fluid/liquid quantity circulating through the conduit 39, depending on the grain size of the abrasive solution employed from time to time, thereby optimizing the effectiveness of the abrasive action on the teeth. Finally, with reference now to FIGS. 11 and 12, in which a third possible embodiment of the abrasive tool according to the invention is shown, it is noted that in this case the handle 16 is adequately shaped for housing two cartridges 12 and 12′ with abrasive paste having respectively different size, for example a small and a large size, and to this aim such handle may be advantageously shaped with an extended envelope 45 projected from the handle back side, in which two separated receptacles (not indicated) are housed, which are adapted to removably accommodate the respective cartridges 12 and 12′ and connected to the fluid/liquid circuits (not indicated too) and with corresponding lock-regulators 42 of the kind referred to, said receptacles being closed by respective closing covers 46 and 47 which can be screwed and unscrewed with respect thereto for introducing or extracting the cartridges with respect to the corresponding receptacles. Besides, in this case the handle 16 is also shaped with a lower projected portion 48 acting as a handle, to which the end portion of the flexible pipe 18 is secured, while the handle end portion 49 is shaped with a male portion 50 removably engaging a female portion 51 of the rod 17 (see FIG. 14), in order to apply the rod on to the handle. In this way, the handle of the abrasive tool referred to lends itself thanks to its compact and simple shape, to be manipulated in an extremely easy manner. Moreover, this tool makes it possible, depending on the treatment needs, to replace quickly and easily each rod to be utilized, and to orient the same rod in different positions, and this rod may be constituted for example by a slightly curved end portion 36 (FIG. 13a), a rectilinear portion (FIG. 13b) or a very curved portion 52 (FIG. 13c), but of course the rod shapes may vary at will in order to satisfy the treatment needs, thus without departing from the protection sphere of the present invention. Furthermore, at the end of use on each patient these rods may be submitted to sterilization for subsequent uses thereof In turn, the abrasive solution falling in the patient's mouth is sucked quickly and continuously and discharged outside by means of traditional aspirators. It is also to point out that the starch used with a function of thickener, so as to maintain suspended for a long time the aluminium hydroxide particles, may be of any type compatible with the human nourishment, and preferably but not necessarily it may be a thickener type Ultra-Sperse 5 of the Firm National Starch & Chemical. FIG. 15 schematically shows the present abrasive tool for dental uses according to the invention in a fourth embodiment. From this Figure, it is noted that the abrasive tool 5 is substantially constituted again by the box-like envelope 6 enclosing the reservoir 7, the high pressure pump 9, the cartridge with large capacity 12′ made of deformable plastic material, which in this case contains water, preferably demineralized water or water treated with disinfectants or made more agreeable with aromatic substances, and the container 13 made of high pressure resistant material in which the cartridge 12′ is housed, which is communicating with the delivery side 14 of the pump 9 through the conduit 15. The abrasive tool is also constituted by the internally hollow extended handle 16 provided with a rod 17, joined to a corresponding end portion of the thin reinforced and extended flexible pipe 18, and entering with its other end portion the wall 19 of the box-like envelope 6 and joined with the upper part of the cartridge 12′ through the conduit 21. In turn, the pump 9 serves to suck the water introduced and contained in the reservoir 7 and to introduce it in the container 13 at a high pressure, such that to cause the compression of the flexible cartridge 12′ and the consequent coming out from this latter, through the conduit 21, of water and other substances contained therein. When the teeth abrasion is required, the pump 9 is driven in rotation and water so sucked from the reservoir is introduced at a high pressure into the container 13, by compressing the cartridge 12′ and providing for the outflow from this latter of water and other substances contained therein, and these liquids by passing through the flexible pipe 18 and the interior of handle 16 and rod 17 are directed against the part of tooth to be treated, by causing the abrasion thereof in the manner which will be described later. When each cartridge 12′ is emptied, it may be removed easily and quickly from its seat and replaced by another cartridge of the same kind. By referring now also to FIG. 17, in which an enlarged and detailed view of the partially cut handle 16 and rod 17 is shown, and in which the inner conduit 53 of the handle 16 is visible, which passes through this latter in a longitudinal direction, and provided with a cartridge filter 54 housed on a corresponding seat provided in the inlet end portion of the handle 16, which is made preferably but not exclusively of sintered metallic material and provided for filtering and retaining any impurity contained in water and other liquid substances coming from the cartridge 12′, it is noted that such handle supports at least a reservoir or cartridge 55 of removable type, containing the abrasive powder 55′ to perform the teeth abrasion in the manner which will be described later, such reservoir or cartridge being made of adequate volume so as to contain abrasive powder in an amount enough to perform several abrasive operations and being shaped with a bottom 56 tapered with a funnel form and closed on its lower part, in order to convey by gravity downwards the abrasive powder contained therein. As abrasive powder it may be employed micronized aluminium hydroxide or any other abrasive powder suitable for performing this function and employed in the dental field. It may be used also a paste added with high concentrated abrasive powder. This reservoir or cartridge 55 is supported and secured removably on to the handle 16 by means of curved wings 57 fixed below its bottom 56, such wings being adaptable to and secured on a corresponding curved portion 58 of the same handle, situated on a position adjacent to the inflow end portion of said handle. In turn, the inner conduit 53 of the handle 16 is joined, at its end portion, with a short convergent tapered hole portion 59 and a calibrated nozzle with capillary hole 60, provided internally an insert 61 with reduced diameter, forced in the outflow end portion of the handle 16. Such fluid/liquid outflow calibrated hole 60, which serves to increase fluid/liquid pressure to cause the effect which will be described later, has preferably a diameter smaller than 10 centimillimeters and greater than 2 centimillimeters. Moreover, the outflow end portion of said handle is provided with an outer threaded portion 62 engaging removably a corresponding threaded ring nut 63, in which an extended insert 64 is introduced, which is shaped in succession with a cylindrical portion 65 and a frusto-conical portion 66 tapered towards its end portion, said extended insert being shaped internally with a venturi conduit 67 with reduced cross-section which is joined, at its one end portion, with an enlarged portion 68 turned towards the capillary hole 60 and communicating therewith, and at its other end portion with a further enlarged end portion 69 communicating with the end portion of said insert frusto-conical portion 66. Besides, the cylindrical portion 65 of said insert is provided with an outer threaded portion 70 to engage removably a corresponding threaded ring nut 71 in which a frusto-conical bush 72 is introduced, which is secured on to an end portion of the rod 17 and has a shape corresponding to that of the insert frusto-conical portion 66, thereby to be adapted on to this latter and determine the applying of the same rod on the handle 16. The present abrasive tool also comprises a flexible and separate conduit 73 with reduced cross-section, made preferably of elastomer, to convey the abrasive powder or paste added with abrasive powder contained in the reservoir or cartridge 55 towards the rod 17, such flexible conduit being arranged on and supported externally the handle 16 and being connected at its one end portion with a thin metallic needle 74 which is introduced tightly through the inclined bottom 56 of said reservoir or cartridge, so as to permit to suck from this latter the abrasive powder or paste added with abrasive powder 55′ and the conveyance through the same flexible conduit thereof, in the manner which will be described later. In turn, the other end portion of the flexible conduit 73 is introduced through the wall of handle 16, which on this point is shaped with an enlarged form, and is communicating with a circular closed room 75 provided around the extended insert 64, and in turn communicating with the conduit enlarged portion 68 through a set of radial through holes 76 provided through the wall of said extended insert. Such flexible conduit end portion is inserted through the enlarged wall of the handle 16 by means of a coupling bush 77, which is forced in a corresponding seat of such handle wall, thereby preventing any undesirable disjunction of the flexible conduit from this position. In this way, it appears evident that the jet of fluid/liquid and other liquid substances, which are introduced in succession in the inner conduit 53 and the handle capillary 60, when they cross at high speed the conduit enlarged portion 68 and the venture conduit 67, produce a depression which determines the suction of the abrasive powder contained in the reservoir or cartridge 55, through the needle 74, the flexible conduit 73, the circular closed room 75 and the radial through holes 76, with consequent mixing of said abrasive powder with fluid/liquid and other liquid substances and conveyance of said mixture at high speed, through the rod 17, against each tooth to be treated. The abrasive tool is also provided with at least a separate roll 78 applied externally into contact relationship with the flexible conduit 73 and acting thereon in a manner to determine a partial squeezing in a variable extent, and consequently different passage cross-sections thereof thereby regulating the amount of abrasive powder being passing through the same conduit, or preventing any passage of such abrasive powder in the case of complete squeezing of said conduit. In order to displace such roll 78 into different regulating positions, by acting with different compression forces against the conduit 73 (see also FIG. 19, in which it is also indicated the squeezed conduit 73), the same roll is supported at an end portion of a pair of rectilinear side arms 79 and 80, the other end portion of which is connected to a cam 81 provided with a lever 82 which can be actuated by the user so as to displace such cam and the associated roll 78 into different positions, depending on the desired squeezing extent of said conduit. Obviously, the flexible conduit 73 may be squeezed also with means different than the cam and the roll referred to, so as to obtain always the same function, thereby without departing from the protection sphere of the present invention. In order to permit the abrasive powder or paste added with abrasive powder to come out from the reservoir or cartridge 55, such reservoir or cartridge is provided with at least an unidirectional inner valve 83, associated with a set of through openings 84 provided through the wall 85 of said reservoir or cartridge, to permit air to enter the inner room 86 of this latter, so as to permit the abrasive powder or paste added with abrasive powder to be sucked through the conduit 73 and to prevent the abrasive powder or paste added with abrasive powder to outflow through these through openings 84. In the example referred to, the valve 83 is a conical shaped valve with a flexible diaphragm and is supported by a central pin 87 fixed through said wall 85, in a manner that to be able to be displaced from a fully raised rest position thereof (see FIG. 17), with consequent closure of said through openings 84 when the suction of abrasive powder or paste added with abrasive powder and the consequent suction of air in the inner room 86 of said reservoir or cartridge isn't required, to a working position (see FIG. 20, drawn with a dashed line) in which the peripheral edge 88 of said valve is slightly raised from the through openings 84, thereby permitting air to pass therethrough and preventing the abrasive powder or paste added with abrasive powder to outflow through the same openings. It is also to point out that the so shaped reservoir or cartridge 55, which is of removable type, may be removed from its seat and discarded, when the abrasive powder or paste added with abrasive powder has been fully discharged, so as to be replaced by another cartridge fully filled with abrasive powder or paste added with abrasive powder, or it may be also provided with an openable and closeable cover, which may be filled or emptied with abrasive powder or paste added with abrasive powder depending on the need. Finally, it is to point out that each rod may be made with different shape and size, in order to be able to have access at different positions and with different energy to the teeth. Thanks to the use of the present abrasive tool, the teeth may be worked by it in an effective and painless manner, without producing vibrations or disagreeable noises, and without causing any psychological and/or psychic discomfort on the patients under treatment, with a simple, quick and reliable operation thereof Moreover, this abrasive tool allows to:
get a very accurate and adjustable abrasive focusing (micro-invasivity);
do not increase or lower significantly the tooth temperature;
provide for a cavity already ready to be treated with the adhesive without the use of etching substances and adapted to be filled with compounds;
have a very compact and manoeuvrable handle;
to get available working angles on the tooth which practically cannot be achieved with
avoid to form “the mass of dust” produced by the air-microparticles system;
get available an instrument of very easy and secure asepticity, in that the very thin rod, which can be compared with a syringe needle, is replaced for each patient. Thereafter, the handle does not have moving parts and its shape is conceived to have no recesses and therefore for being easily sterilized.

FIG. 16 shows now the present abrasive tool on a fifth embodiment thereof, in which it is noted that it is always constituted like that previously described (namely with the handle with reservoir or cartridge and rod which are identical to the preceding one), so that its component parts here represented are marked with the same reference numerals, and differs from the tool referred to in that in this case the box-like envelope 6 isn't provided with the cartridge 12′ and the container 13, and the flexible pipe 18 is joined at its free end portion directly downstream the pressure regulator 24. Then, in this case the reservoir 7 is filled with the same substances previously contained in the cartridge 12′, namely fluid/liquids, preferably demineralized water, or water treated with disinfectants or made more agreeable with aromatic substances.

1. Abrasive tool for dental uses, adapted to act on the teeth of persons for performing abrasive operations on the same teeth, so as to remove decayed parts etc. . . . therefrom, characterized by first fluid/liquid container means (7) provided with heating means (23) to keep fluids/liquids at a pre-established temperature; second fluid/liquid container means (13) communicating with said first container means (7) through pumping means (9); third container means (12, 55) of an abrasive solution; and handle means (16) connected with at least a rod (17) and shaped for being handled and oriented toward the teeth parts to be treated and communicating with said pumping means (9) through flexible and reinforced conveyor means (18); said pumping means (9) being controlled in such a way that to draw fluids/liquids from said first container means (7) and to convey them into said second container means (13), with such a high pressure that to convey the relative abrasive solution contained into said third container means (12, 55) through said handle means (16) and said rod (17), by directing it at very high speed in the form of a jet of fluids/liquids and abrasive solution against the teeth parts to be treated, with subsequent final suction of fluids/liquids and said abrasive solution from the patient's mouth.

2. Abrasive tool according to claim 1, characterized in that said first, second and third container means (7, 13, 12) are enclosed into at least a box-like envelope (6), together with said pumping means (9), and that said second and third container means (13, 12) are co-operating with valve means (20), connected with said flexible conveyor means (18) and movable from a first to a second operative position, so as to put into communication selectively said second or said third container means (13, 12) with said handle means (16).

3. Abrasive tool according to claim 2, characterized in that said valve means comprise at least a valve member (20) communicating through a first conduit (21) with the interior of said third container means (12) and through a second conduit (22) with the interior of said second container means (13), said valve member (20) being shaped with an inner switching element (32) provided with an inner through conduit (33) communicating with said flexible conveyor means (18) and controlled by an outer handle (34), in a manner to be displaced from said first to said second operative position, in which said inner conduit (33) is put into communication respectively with said second conduit (22) or said first conduit (21).

4. Abrasive tool according to claim 1, characterized in that said first container means (7) are enclosed by at least a box-like envelope (6), together with said pumping means (9), which are connected to said flexible conveyor means (18), and that said second and third container means (13, 12) are housed on an enlarged portion (37) of said handle means (16) and are associated with valve means (43, 44) provided into said handle means (16) and adapted to regulate fluid/liquid flow through said second and third container means (13, 12).

5. Abrasive tool according to claim 4, characterized by regulating means (42) housed into said enlarged portion (37) and acting on to said third container means (12) to meter the quantity of abrasive solution flowing out therefrom.

6. Abrasive tool according to claim 5, characterized in that said handle (16) is shaped with an extended envelope (45), which is projected from the back side of the same handle, so as to accommodate one or more of said second and third container means (13; 12, 12′) and is also provided with a lower projected portion (48) acting as a handle, secured to said flexible conveyor means (18).

7. Abrasive tool according to claim 6, characterized in that said third container means are constituted by at least a cartridge (12) made of flexible material, preferably of deformable plastic material, and having different shapes and sizes.

8. Abrasive tool according to claim 1, characterized in that said handle means (16) are communicating, through said flexible and reinforced conveyor means (18), with said first container means (7) or possible fourth container means (12′), both containing fluid/liquid, preferably demineralized water, or water treated with disinfectants and/or aromatic substances, wherein said fourth container means (12′) are introduced into the corresponding said second container means (13), and characterized in that said pumping means (9) are connected also with said possible fourth container means (12′) and controlled in a manner to convey fluid/liquid at a high pressure from said first container means (7) or said possible fourth container means (12′) through said handle means (16) and said rod (17).

9. Abrasive tool according to claim 8, characterized in that said first container means (7) and said possible fourth container means (12′) are enclosed by at least a box-like envelope (6), together with said pumping means (9).

10. Abrasive tool according to claim 8, characterized in that said third container means (55) are constituted by at least a reservoir or cartridge (55) supported on and secured to said handle means (16), by fixing means (57), as well as shaped for containing abrasive powder or paste added with adhesive powder (55′) on a quantity enough to perform several abrasive operations, and shaped with a bottom (56) tapered with a funnel form and closed on its lower part, communicating through at least a needle (74) inserted through said bottom (56), and a flexible conduit (73) supported by said handle means (16), with the interior of said handle means (16) and said rod (17), to convey said abrasive powder or paste added with abrasive powder from the interior of said reservoir or cartridge (55) through said needle (74), said flexible conduit (73) and the interior of said handle means (16) and said rod (17), said conveyance being effected by suction means (67) arranged between the end portion of said handle means (16) and said rod (17), regulating means (78) being also provided and associated with said flexible conduit (73), so as to vary the quantity of abrasive powder or paste added with abrasive powder passing through the same conduit.

11. Abrasive tool according to claim 10, characterized in that said fixing means are constituted by curved wings (57) or the like, secured below said bottom (56) and adaptable on a corresponding curved portion (58) of said handle means (16), situated on a position adjacent to the inflow end portion of the same handle means.

12. Abrasive tool according to claim 10, characterized in that said suction means are constituted by at least a venturi conduit (67) with reduced cross-section provided internally an extended insert (64) introduced in a corresponding ring nut (63) engaging the end portion of said handle means (16), said venturi conduit (67) communicating with the interior of said handle means (16) through an enlarged portion (68) turned towards a corresponding calibrated nozzle with capillary hole (60), inserted removably into said end portion, said venturi conduit (67) communicating also with the interior of said rod (17) through a further enlarged portion (69), said extended insert (64) being provided with at least another threaded ring nut (71) or the like, for supporting and fixing the corresponding end portion of said rod (17).

13. Abrasive tool according to claim 10, characterized in that said regulating means are constituted by at least a separate roll (78) applied externally into contact relationship with said flexible conduit (73), supported at an end portion of a pair of rectilinear vertical arms (79, 80), the other end portion of which is connected to a cam (81) provided with a lever (82) which can be actuated by the user into different operative positions, said roll (78) being actuatable by said lever (82) and said cam (81) into different regulating positions, by acting with different squeezing forces against said flexible conduit (73), so as to vary the passage cross-sections thereof.

14. Abrasive tool according to claim 10, characterized by unidirectional valve means (83) housed and supported internally said reservoir or cartridge (55), and acting against through openings (84) of this latter, so as to permit air to enter said reservoir or cartridge (55) only when the abrasive powder or paste added with abrasive powder is sucked and prevent such abrasive powder or paste added with abrasive powder to outflow through said through openings (84).

15. Abrasive tool according to claim 1, characterized in that said pumping means comprise at least a high pressure liquid pump (9) of conventional type, the suction side (10) of which is communicating with said first container means (reservoir 7) and the delivery side (14) of which is communicating with said second and third container means (13; 12, 55) and said possible fourth container means (12′).

16. Abrasive tool according to claim 15, characterized by comprising pressure regulating means (24) associated with said pumping means (9) and set for regulating the pressure of fluids/liquids introduced into said first container means (7) and said second container means (13), and by comprising also fluid/liquid pressure gauge means (31) associated with said delivery side (14) of said liquid pump (9).

17. Abrasive tool according to claim 1, characterized in that said abrasive powder is constituted preferably by micronized aluminium hydroxide.

18. Abrasive tool according to claim 1, characterized in that said abrasive solution is constituted by a solution of micronized aluminium hydroxide, water and at least a starch of conventional type, mixed together with pre-established ratios thereof.

19. Abrasive tool according to claim 1, characterized in that said abrasive solution is constituted by a paste added with abrasive powder.

20. Abrasive tool according to claim 1, characterized in that said rod (17) is constituted with end portions of different shapes, for example of rectilinear shape, slightly curved shape (36), too curved shape (2) etc. . . .
